(19) United States
(12) Patent Application Publication
(10) Pub. No.: US 2026/0273420 A1
(43) Pub. Date: Sep. 17, 2026

(54) GEOFENCING BASED PARENTAL CONTROL

(71) Applicant: Sony Interactive Entertainment Inc., Tokyo (JP)

(72) Inventors: Robert Jordan, Alameda, CA (US); Bethany Tinklenberg, San Francisco, CA (US); Sarah Anne Karp, San Mateo, CA (US); Micah Ray Mison, Daly City, CA (US); Tatianna Forget, Mountain View, CA (US); Jin Zhang, Belmont, CA (US); Rahma Mahdi, Oakland, CA (US)

(73) Assignee: Sony Interactive Entertainment Inc., Tokyo (JP)

(21) Appl. No.: 19/076,893

(22) Filed: Mar. 11, 2025

(51) Int. Cl. A63F 13/73; A63F 13/216; H04W 4/02; H04W 4/021

(52) U.S. Cl. CPC A63F 13/73; A63F 13/216; H04W 4/021; H04W 4/025

(57) ABSTRACT

Systems and methods include executing a game environment where a geofencing application executes in the game environment. The method further includes receiving a plurality of criteria for establishing a geofence within the gaming environment from a user gaming device associated with a user, identifying a user location based on location data retrieved from a user device, establishing the geofence based on the user location and the user provided criteria, and receiving a plurality of rules for establishing an interaction within the geofence. The method includes receiving a request for an interaction with the user gaming device from a requesting gaming device, automatically initiating the geofencing application in the game environment, verifying that the requesting gaming device is within the geofence, verifying that the requesting gaming device satisfies the plurality of rules for establishing the interaction, and establishing the interaction between the user gaming device and the requesting gaming device.

### BACKGROUND

The video game industry has expanded significantly such that users have virtually infinite options for video games and other media types for interaction. Example gaming platforms may be the Sony Playstation®, Sony Playstation2® (PS2), Sony Playstation3® (PS3), Sony Playstation3® (PS4), Sony Playstation3® (PS5), etc., each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. Online gaming is also possible, where a user can interactively play against or with other users over the Internet. Other gaming platforms may include Playstation® Portal and Playstation® VR2. Today's game console is not used just to play games, but are used as a computing device that can access the Internet to search for content, browse for multimedia downloads, shop online music, videos or movies, participate in multiplayer games, enter virtual words, etc. Thus, a community of users is accessing online media, and this community of users has powerful computing devices and versatile interfaces.

Gaming platforms available today connect users from across the globe. This is valuable for many reasons. However, a parent may not wish for their children to interact with certain users online, for example, people that the parent/child do not actually know in real life. Accordingly, traditional parental controls have been provided to limit these interactions. Traditional parental controls are often limited to allowing or blocking individuals on a case-by-case basis. Embodiments of the present disclosure provide customizable boundaries for interacting with user devices within a game environment and further within a geographical boundary defined by the user device.

### SUMMARY

Embodiments of the present invention provide methods, systems, and computer programs for executing an adaptive player matching application for interacting on a platform.

According to one embodiment, a method includes executing, by a system comprising a processor and a memory, a game environment where a geofencing application executes in the game environment. The method further includes receiving, by the system, a plurality of criteria for establishing a geofence within the gaming environment from a user gaming device associated with a user, identifying a user location based on location data retrieved from a user device, establishing the geofence based on the user location and the user provided criteria, and receiving, by the system, a plurality of rules for establishing an interaction within the geofence. The geofence defines a geographical boundary within which the user is allowed to interact with other users based on the plurality of criteria. The method further includes receiving, by the system, a request for an interaction with the user gaming device from a requesting gaming device, automatically initiating, by the system, the geofencing application in the game environment, verifying, by the geofencing application, that the requesting gaming device is within the geofence, verifying, by the geofencing application, that the requesting gaming device satisfies the plurality of rules for establishing the interaction, and establishing, by the geofencing application, the interaction between the user gaming device and the requesting gaming device.

The method may include various optional embodiments. The method may further include defining, by the system, a plurality of layers within the geofence based on the user provided criteria. The plurality of rules for establishing an interaction within an innermost layer of the plurality of layers defined by the geofence may be more restrictive than a plurality of rules for establishing an interaction within an outermost layer of the plurality of layers defined by the geofence. The plurality of rules for establishing an interaction within the outermost layer may include parental approval. The method may further include, in response to determining that the requesting gaming device is in the outermost layer, outputting a request for parental confirmation that the requesting gaming device satisfies the plurality of rules for establishing an interaction. Verifying that the requesting gaming device is within the geofence may include identifying at least one secondary electronic device that is in proximity to the requesting gaming device and verifying that the at least one secondary electronic device is in the geofence. Verifying that the requesting gaming device is within the geofence may include accessing server information associated with the requesting gaming device where the server information validates a geolocation of the requesting gaming device. Verifying that the requesting gaming device satisfies the plurality of rules for establishing the interaction may include accessing a database to identify an electronic account associated with the requesting gaming device and identifying, from the electronic account, information associated with the requesting gaming device. Verifying that the requesting gaming device satisfies the plurality of rules for establishing the interaction may include outputting a request for parental confirmation that the requesting gaming device satisfies the plurality of rules.

According to another embodiments, a system includes one or more storage media storing instructions and one or more processors to execute the instructions causing the system to perform operations. The operations include executing a game environment where a geofencing application executes in the game environment. The operations include receiving, by the system, a plurality of criteria for establishing a geofence within the gaming environment from a user gaming device associated with a user, identifying a user location based on location data retrieved from a user device, establishing the geofence based on the user location and the user provided criteria, and receiving, by the system, a plurality of rules for establishing an interaction within the geofence. The geofence defines a geographical boundary within which the user is allowed to interact with other users based on the plurality of rules. The operations include receiving, by the system, a request for an interaction with the user gaming device from a requesting gaming device, automatically initiating, by the system, the geofencing application in the game environment, verifying, by the geofencing application, that the requesting gaming device is within the geofence, verifying, by the geofencing application, that the requesting gaming device satisfies the plurality of rules for establishing the interaction, and establishing, by the geofencing application, the interaction between the user gaming device and the requesting gaming device.

The system may include various optional embodiments. Operations may include defining, by the system, a plurality of layers within the geofence based on the user provided rules. A plurality of rules for establishing an interaction within an innermost layer of the plurality of layers defined by the geofence may be more restrictive than a plurality of rules for establishing an interaction within an outermost layer of the plurality of layers defined by the geofence. The plurality of rules for establishing an interaction within the outermost layer may include parental approval. The operations may further include, in response to determining that the requesting gaming device is in the outermost layer, outputting a request for parental confirmation that the requesting gaming device satisfies the plurality of rules for establishing an interaction. Verifying that the requesting gaming device is within the geofence may include identifying at least one secondary electronic device that is in proximity to the requesting gaming device and verifying that the at least one secondary electronic device is the geofence. Verifying that the requesting gaming device is within the geofence may include accessing server information associated with the requesting gaming device where the server information validates a geolocation of the requesting gaming device. Verifying that the requesting gaming device satisfies the plurality of rules for establishing the interaction may include accessing a database to identify an electronic account associated with the requesting gaming device, and identifying, from the electronic account, information associated with the requesting gaming device. Verifying that the requesting gaming device satisfies the plurality of rules for establishing the interaction may include outputting a request for parental confirmation that the requesting gaming device satisfies the plurality of rules.

According to another embodiment, one or more non-transitory computer-readable storage media store instructions that, upon execution by one or more processors of a system, cause the system to execute a game environment where a geofencing application executes in the game environment, receive a plurality of criteria for establishing a geofence within the gaming environment from a user gaming device associated with a user, identify a user location based on location data retrieved from a user device, establish the geofence based on the user location and the user provided criteria, and receive a plurality of rules for establishing an interaction within the geofence. The geofence defines a geographical boundary within which the user is allowed to interact with other users based on the plurality of rules. The instructions further cause the system to receive a request for an interaction with the user gaming device from a requesting gaming device, automatically initiate the geofencing application in the game environment, verify, by the geofencing application, that the requesting gaming device is within the geofence, verify, by the geofencing application, that the requesting gaming device satisfies the plurality of rules for establishing the interaction, and establish, by the geofencing application, the interaction between the user gaming device and the requesting gaming device.

The non-transitory computer-readable storage media may include various optional embodiments. Verifying that the requesting gaming device is within the geofence may include identifying at least one secondary electronic device that is in proximity to the requesting gaming device and verifying that the at least one secondary electronic device is in the geofence. Verifying that the requesting gaming device satisfies the plurality of rules for the respective layer for establishing the interaction may include accessing a database to identify an electronic account associated with the requesting gaming device, and identifying, from the electronic account, information associated with the requesting gaming device. Verifying that the requesting gaming device satisfies the plurality of rules for establishing the interaction may include accessing a database to identify an electronic account associated with the requesting gaming device, and identifying, from the electronic account, information associated with the requesting gaming device.

### BRIEF DESCRIPTION OF THE DRAWINGS

Features, embodiments, and advantages of the present disclosure are better understood when the following Detailed Description is read with reference to the accompanying drawings.

FIG. 1 illustrates a computer system, according to embodiments of the present disclosure.

FIG. 2 illustrates an exemplary implementation of a geofencing application, according to embodiments of the present disclosure.

FIG. 3 is a flowchart of a method for executing a geofencing application in a game environment, according to embodiments of the present disclosure.

FIG. 4 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

Embodiments of the present disclosure provide systems and methods for establishing a geofence and interactions between user devices within the geofence. A geofence as described herein may refer to a geographical boundary. The geographical boundary may be defined by a plurality of criteria provided by a user upon creation of a profile and/or prior to engaging with a gaming environment. The user may further provide a plurality of rules for establishing interactions with other user devices within the geofence once the other user devices are validated within the geofence. Accordingly, embodiments of the present disclosure enable a user to customize and define boundaries for interacting with user devices within a game environment and further within a geographical boundary defined by the user device. A gaming system and game environment for executing these various embodiments are further described herein.

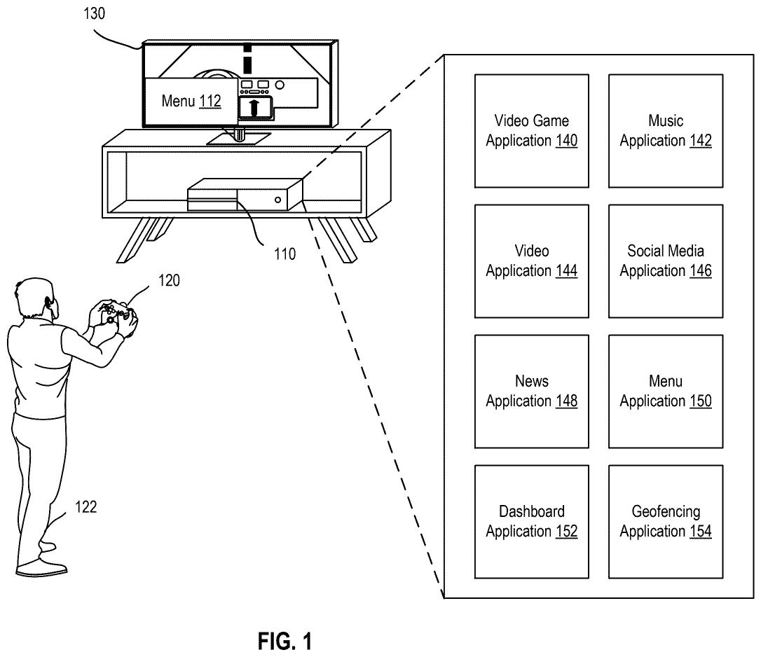

FIG. 1 illustrates a computer system, according to an embodiment of the present disclosure. As illustrated, the computer system 100 includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A user 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login). In addition, the video game console 110 includes a menu application 150, a dashboard application 152, and a geofencing application 154. The menu application 150 can present a home user interface (UI) in a GUI of the display 130. The dashboard application 152 can present an arrangement of interactive UI widgets in a dashboard page on the GUI.

The video game controller 120 is an example of an input device. The video game controller 120 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150, the dashboard application 152, or the geofencing application 154 as applicable) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user control changes from the underlying application to the video game application 140.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 152 may generate and/or present widgets associated with media applications, system applications and/or services, video game applications, or the like.

As described in more detail below, the dashboard application 152 may be executed via multiple avenues of ingress. For example, the dashboard application 152 may be executed by a pre-defined user interaction (e.g., via controller 120, a voice command from the user 122, activating and/or powering-on the video game consol 110 etc.) and/or by navigating one or more menus and/or sub-menus of the video game console 110 (e.g., menu 112).

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

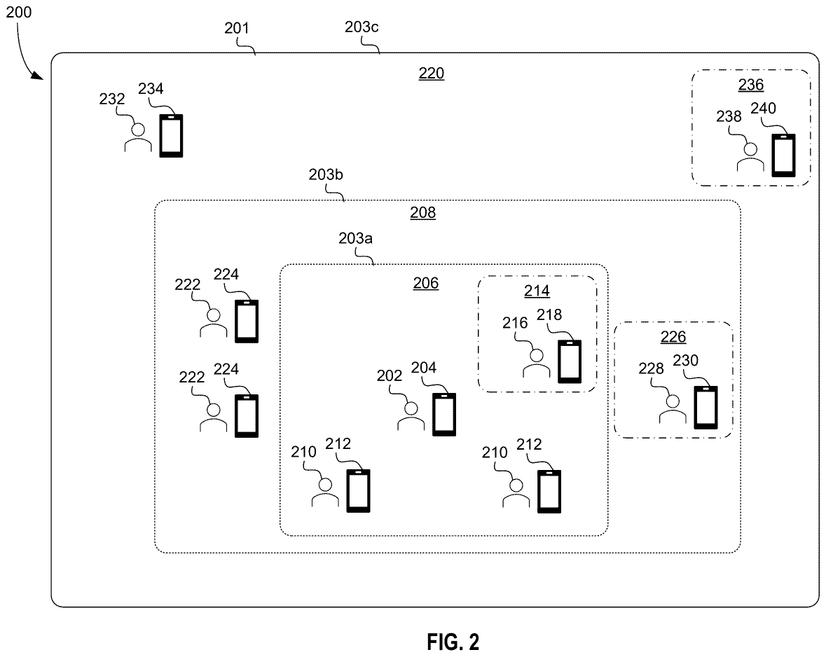

FIG. 2 illustrates an exemplary implementation of a geofencing application (e.g., the geofencing application 154 illustrated in FIG. 1) in a game environment 200. The game environment 200 includes a user 202 and a user device 204 associated with the user 202. Other users and associated user devices may also be part of the game environment via wired or wireless connections over a network. According to some embodiments, a game environment 200 may be a platform that hosts one or more game titles where users from all over the world may play the one or more titles alone or with other players. According to various embodiments described herein, a geofencing application may be launched in the game environment 200.

In some embodiments, the game environment 200 (e.g., a system running the game environment 200 as would be appreciated by one having ordinary skill in the art) receives a plurality of criteria for establishing a geofence 201 within the gaming environment 200. The geofence 201 defines a geographical boundary within which the user 202 is allowed to interact with other users based on the plurality of criteria. The plurality of criteria may be received from the user device 204 associated with the user 202. The criteria may be input by the user 202 upon creation of a profile and/or prior to engaging with the game in the game environment 200. The criteria may include and/or define a geographical boundary defining the geofence 201 and geographical boundaries (e.g., layers 203) within the geofence 201 (to be described in further detail below), other location information such as a type of location data (e.g., GPS data, coordinates, etc.) that may be used to define the geofence 201 and/or the location of the user and other users, etc. The geofence 201 may be personalized to user 202 and customizable according to the embodiments as described herein.

According to various embodiments, the geofence 201 may include one or more layers 203. A layer may be a geographical boundary within the geofence 201. The plurality of layers 203 may overlap each other (e.g., in a stacked configuration, as shown in FIG. 2) according to some embodiments. An outermost layer 220 may be coincident with the outermost boundary of the geofence 201 as further shown in FIG. 2. According to various embodiments, inner layers of the plurality of layers 203 are geographical boundaries within the outermost layer 220.

According to various embodiments, the system executing the game environment 200 may further receive a plurality of rules for establishing interactions between user devices in the geofence from the user 202. Rules may include parental controls such as age restrictions, connection approval requirements, geographic limitations, etc. The plurality of rules may be applied to all layers within a plurality of layers 203 of the geofence 201. In other embodiments, each layer 203 may be associated with its own plurality of rules such that some layers have more restrictions than others. For example, a plurality of rules may be received for establishing an interaction within each layer of the plurality of layers 203 within the geofence 201. According to some embodiments, a first geofence layer 206 may be established based on the user location and the user provided criteria. Other layers 203 of the plurality of layers 203 may be defined within the geofence 201 based on the user provided criteria.

In some embodiments, the establishing the geofence 201 may include identifying a user location based on location data from the user device 204. Location data may include GPS data, vector data, raster data, etc., or any other type of geospatial data known in the art. The user location may be identified in other manners such as via connections to servers in the game environment 200, relative location to other user devices (such as user device 212, user device 218, etc.), information derived from a user profile associated with the user 202, etc. In various embodiments, a plurality of rules for establishing an interaction within an innermost layer (e.g., the first layer 206) of the plurality of layers 203 defined by the geofence 201 are more restrictive than a plurality of rules for establishing an interaction within an outermost layer (e.g., the third layer 220) of the plurality of layers 203 defined by the geofence 201. For example, a parent may set the first layer 206 of the geofence 201 to include user devices 212 associated with users 210 within a neighborhood that the user 202 likely knows. In further embodiments, a plurality of rules within the first layer 206 may be further refined for a region 214 within the first layer 206. For example, the region 214 may refer to a specific user device 218 associated with a user 216 that has been previously validated by the geofencing application and/or is affirmatively approved as part of criteria for the first layer 206 and region 214. A parent may decide that the user device 218 is associated with their child's friend or relative and to automatically allow requests from this user device 218. In contrast, a plurality of rules for the first layer 206 may include at least parental consent for the interaction even within the first layer 206.

In other embodiments, a region (such as region 214, region 226, region 236, etc.) within a layer 203 may refer to users that are automatically restricted or requests that are otherwise denied. For example, a region may refer to user devices at addresses associated with sex offenders or other criminals (as validated via government websites or the like). As such, parents may further limit interactions with specific users within a layer 203.

In some embodiments, a second layer 208 may be defined within the geofence 201 for the state, country, or broader region including the user device 202. For example, a parent may choose to allow requests from users 222 (e.g., user devices 224 associated with the users 222) within the second layer 208 but the user devices must comply with a different plurality of rules than the plurality of rules that apply to the first layer 206. The second layer 208 may also include a region 226 with a further defined plurality of rules or exceptions. For example, a parent may restrict requests from user devices 224 within the country to user devices 224 associated with users 222 that are within a predefined age range (e.g., as validated by a user profile or other interactions with the users 222) but outside of their neighborhood, except for requests from a validated relative (e.g., a user 228 associated with a user device 230).

According to some embodiments, a third layer 220 may be a larger region within the geofence 201 or a global region of the geofence 201. The plurality of rules for establishing an interaction with the user device 204 may be most restrictive in the outermost layer, according to various embodiments. For example, a parent may restrict (e.g., automatically deny) any requests from user devices 234 associated with users 232 located outside the country or the second layer 208. However, region 236 may represent a validated relative (e.g., a user 238 associated with a user device 240) where a request for an interaction may be automatically accepted.

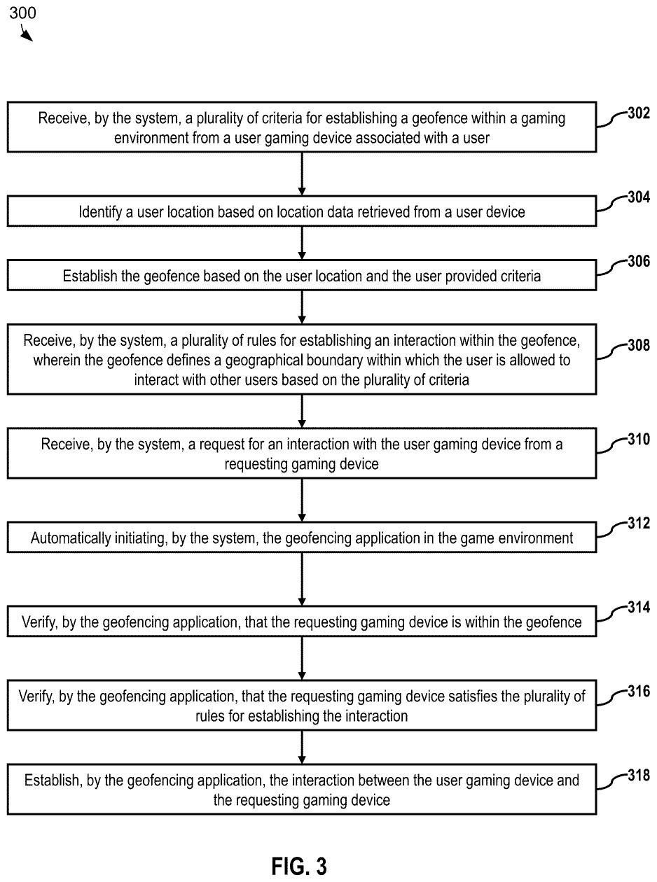

According to various embodiments, within the game environment 200, a system including the user device 204 may receive a request for an interaction with another user device (such as user device 212, user device 218, etc.). In response to the request, the system may automatically launch the geofencing application in the game environment 200. In other embodiments, the geofencing application always operates within the game environment 200 as a background application. The geofencing application proceeds to verify the location of the requesting user device and validate that the requesting user device is within the geofence and meets the criteria established for the layer of the geofence in which the requesting user device is identified. Embodiments of the verification are further discussed with respect to process 300 of FIG. 3.

FIG. 3 is a flowchart of a method of executing a geofencing application in a game environment, such as game environment 200. Process 300 includes executing, by a system comprising a processor and a memory, the game environment such as the game environment 200 described in detail above. Block 302 includes receiving, by the system, a plurality of criteria for establishing a geofence within the gaming environment from a user gaming device associated with a user. The plurality of criteria may be received from a user device associated with the user. The criteria may be input by the user upon creation of a profile and/or prior to engaging with the game in the game environment. The criteria may be location driven for defining the geofence as a geographical boundary for establishing interactions between user devices. The criteria may by further updated by the user as desired. A geofence may be personalized to the user and customizable according to the embodiments as described herein.

Block 304 includes identifying a user location based on location data from a user device. The user location may be identified in other manners such as via connections to servers in the game environment, relative location to other user devices, information derived from a user profile associated with the user, etc. Block 306 includes establishing the geofence based on the user location and the user provided criteria. According to some embodiments, a first geofence layer may be established based on the user location and the user provided criteria as described above.

Block 308 includes receiving, by the system, a plurality of rules for establishing an interaction within the geofence. According to various embodiments, the system may further receive rules from the user for establishing interactions between user devices in the geofence. Rules may include parental controls such as age restrictions, connection approval requirements, geographic limitations, etc. The rules may be received by the system upon creation of a profile and/or prior to engaging with the game in the game environment. The rules may be updated as desired by the user.

Block 308 may further optionally include receiving a plurality of rules for establishing an interaction within each layer of the plurality of layers within the geofence. According to various optional embodiments, process 300 may further include defining, by the system, other layers of the plurality of layers within the geofence based on the user provided criteria. A plurality of rules for establishing an interaction within an innermost layer of the plurality of layers (where applicable) defined by the geofence may be more restrictive than a plurality of rules for establishing an interaction within an outermost layer of the plurality of layers defined by the geofence. In various embodiments, a plurality of rules for establishing an interaction within an innermost layer (e.g., the first layer) of the plurality of layers defined by the geofence are more restrictive than a plurality of rules for establishing an interaction within an outermost layer of the plurality of layers defined by the geofence. For example, the plurality of criteria for establishing an interaction within the outermost layer includes requiring parental approval.

Block 310 includes receiving, by the system, a request for an interaction with the user gaming device from a requesting gaming device. In response to receiving the request, block 312 includes automatically initiating, by the system, the geofencing application in the game environment. In some embodiments, the geofencing application is executed and initiated in response to the request. In other embodiments, the geofencing application is always running as a background application in the system and automatically initiates in response to the response.

Block 314 includes verifying, by the geofencing application, that the requesting gaming device is within the geofence based on the plurality of criteria. For example, the location of the requesting gaming device may be determined via GPS data and/or in response to identifying at least one secondary electronic device that is in proximity to the requesting gaming device and verifying that the at least one secondary electronic device is in the layer of the plurality of layers defined by the geofence. Block 314 may further include verifying which layer within the plurality of layers the requesting user device is in. In some embodiments, block 314 includes accessing server information associated with the requesting gaming device where the server information validates a geolocation of the requesting gaming device. Block 314 may further include pulling or otherwise receiving the plurality of criteria that is applicable to the layer.

Block 316 includes verifying, by the geofencing application, that the requesting gaming device satisfies the plurality of rules for establishing the interaction. In further embodiments, block 316 may optionally include verifying, by the geofencing application, that the requesting gaming device satisfies the plurality of rules for establishing the interaction for the respective layer for establishing the interaction. For example, in response to determining that the requesting gaming device is in the outermost layer, process 300 may include outputting a request for parental confirmation that the requesting gaming device satisfies the plurality of rules for establishing an interaction. A parent may have to manually review and approve the request prior to establishing the interaction. In some embodiments, block 318 includes accessing a database to identify an electronic account associated with the requesting gaming device, and identifying, from the electronic account, information associated with the requesting gaming device.

Block 318 includes establishing, by the geofencing application, the interaction between the user gaming device and the requesting gaming device. The interaction between the user gaming device and the requesting gaming device may be established in a manner known in the art such that the devices may engage with one or more games together.

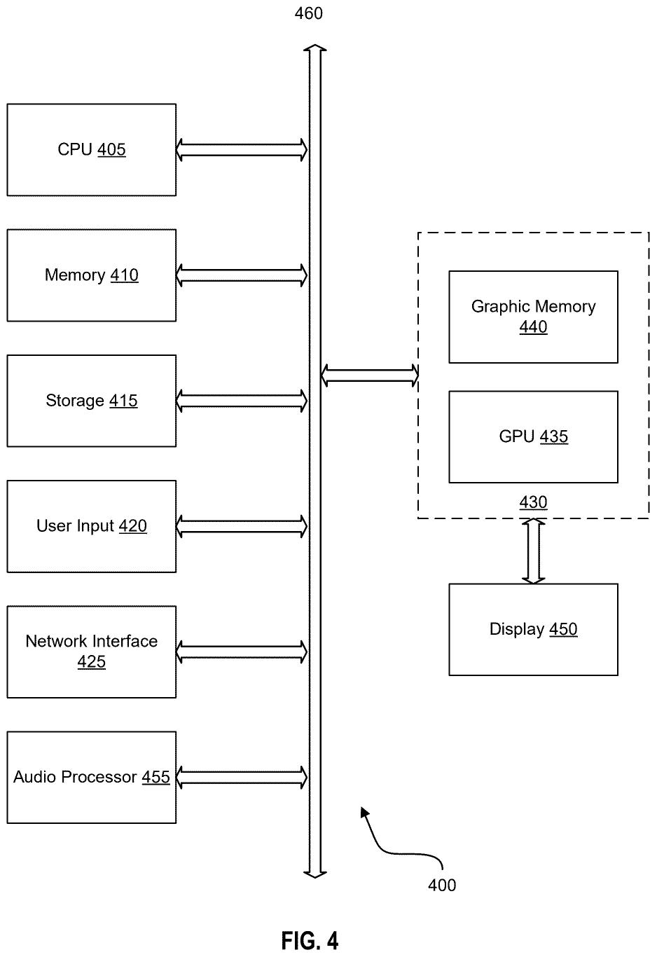

FIG. 4 illustrates an example of a hardware system suitable for implementing a computer system, according to embodiments of the present disclosure. The computer system 400 represents, for example, a video game system, a backend set of servers, or other types of a computer system. The computer system 400 includes a central processing unit (CPU) 405 for running software applications and optionally an operating system. The CPU 405 may be made up of one or more homogeneous or heterogeneous processing cores. Memory 410 stores applications and data for use by the CPU 405. Storage 415 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 420 communicate user inputs from one or more users to the computer system 400, examples of which may include keyboards, mice, thumbsticks, touch pads, touch screens, still or video cameras, and/or microphones. Network interface 425 allows the computer system 400 to communicate with other computer systems via an electronic communications network and may include wired or wireless communication over local area networks and wide area networks such as the Internet. An audio processor 455 is adapted to generate analog or digital audio output from instructions and/or data provided by the CPU 405, memory 410, and/or storage 415. The components of computer system 400, including the CPU 405, memory 410, data storage 415, user input devices 420, network interface 425, and audio processor 455 are connected via one or more data buses 460.

A graphics subsystem 430 is further connected with the data bus 460 and the components of the computer system 400. The graphics subsystem 430 includes a graphics processing unit (GPU) 435 and graphics memory 440. The graphics memory 440 includes a display memory (e.g., a frame buffer) used for storing pixel data for each pixel of an output image. The graphics memory 440 can be integrated in the same device as the GPU 435, connected as a separate device with the GPU 435, and/or implemented within the memory 410. Pixel data can be provided to the graphics memory 440 directly from the CPU 405. Alternatively, the CPU 405 provides the GPU 435 with data and/or instructions defining the desired output images, from which the GPU 435 generates the pixel data of one or more output images. The data and/or instructions defining the desired output images can be stored in the memory 410 and/or graphics memory 440. In an embodiment, the GPU 435 includes 3D rendering capabilities for generating pixel data for output images from instructions and data defining the geometry, lighting, shading, texturing, motion, and/or camera parameters for a scene. The GPU 435 can further include one or more programmable execution units capable of executing shader programs.

The graphics subsystem 430 periodically outputs pixel data for an image from the graphics memory 440 to be displayed on the display device 450. The display device 450 can be any device capable of displaying visual information in response to a signal from the computer system 400, including CRT, LCD, plasma, and OLED displays. The computer system 400 can provide the display device 450 with an analog or digital signal.

In accordance with various embodiments, the CPU 405 is one or more general-purpose microprocessors having one or more processing cores. Further embodiments can be implemented using one or more CPUs 405 with microprocessor architectures specifically adapted for highly parallel and computationally intensive applications, such as media and interactive entertainment applications.

Various embodiments of the present disclosure enable a user to customize geographical and user-based limitations for establishing interactions with other user devices. This may be particularly advantageous for parents who wish to customize parental controls for their children on a broader geographical basis and on a user-by-user basis. Embodiments of the present disclosure enable a parent to set their parental controls such that other kids in the neighborhood are generally allowed interactions while specifically avoiding user devices located at particular addresses, for example, that are associated with sex offenders, bullies, or the like. Conversely, the parent can prevent all interactions outside the state except for pre-approved user devices.

Embodiments of the present disclosure may be used for other purposes in addition to parental controls. For example, a user looking for another user to engage with a game title with may prefer to play with a user in their state (e.g., due to having a similar time zone, etc.) who is within a predetermined age group and/or users who have similar preferences (e.g., an amount of time they like to play at once, a type of gameplay, etc.). The various embodiments of the present disclosure enable the user to customize both geographic restrictions and user preferences distinct from the geographic restrictions.

Techniques described herein further provide several technical advantages over conventional systems. For example, techniques described herein can enable locating user devices and related user devices for creating geofences and processing criteria and rules associated therewith in real-time. These embodiments offer significant advantages over existing systems which are often limited to geographical radiuses such as “within 10 miles” or “within the state of California.” Accordingly, the system assures that users are presented with valuable customization capabilities for fostering a dynamic, personalized gaming environment. By optimizing data processing and reducing delays, the system ensures a seamless and dynamic user experience while maintaining high performance and scalability.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method comprising:
executing, by a system comprising a processor and a memory, a game environment, wherein a geofencing application executes in the game environment;
receiving, by the system, a plurality of criteria for establishing a geofence within the gaming environment from a user gaming device associated with a user;
identifying a user location based on location data retrieved from a user device;
establishing the geofence based on the user location and the user provided criteria;
receiving, by the system, a plurality of rules for establishing an interaction within the geofence, wherein the geofence defines a geographical boundary within which the user is allowed to interact with other users based on the plurality of criteria;
receiving, by the system, a request for an interaction with the user gaming device from a requesting gaming device;
automatically initiating, by the system, the geofencing application in the game environment;
verifying, by the geofencing application, that the requesting gaming device is within the geofence;
verifying, by the geofencing application, that the requesting gaming device satisfies the plurality of rules for establishing the interaction; and
establishing, by the geofencing application, the interaction between the user gaming device and the requesting gaming device.

2. The method of claim 1, further comprising:
defining, by the system, a plurality of layers within the geofence based on the user provided criteria, wherein the plurality of rules for establishing an interaction within an innermost layer of the plurality of layers defined by the geofence are more restrictive than a plurality of rules for establishing an interaction within an outermost layer of the plurality of layers defined by the geofence.

3. The method of claim 2, wherein the plurality of rules for establishing an interaction within the outermost layer comprises parental approval.

4. The method of claim 2, further comprising, in response to determining that the requesting gaming device is in the outermost layer, outputting a request for parental confirmation that the requesting gaming device satisfies the plurality of rules for establishing an interaction.

5. The method of claim 1, wherein verifying that the requesting gaming device is within the geofence comprises identifying at least one secondary electronic device that is in proximity to the requesting gaming device; and verifying that the at least one secondary electronic device is in the geofence.

6. The method of claim 1, wherein verifying that the requesting gaming device is within the geofence comprises accessing server information associated with the requesting gaming device, wherein the server information validates a geolocation of the requesting gaming device.

7. The method of claim 1, wherein verifying that the requesting gaming device satisfies the plurality of rules for establishing the interaction comprises accessing a database to identify an electronic account associated with the requesting gaming device, and identifying, from the electronic account, information associated with the requesting gaming device.

8. The method of claim 1, wherein verifying that the requesting gaming device satisfies the plurality of rules for establishing the interaction comprises outputting a request for parental confirmation that the requesting gaming device satisfies the plurality of rules.

9. A system comprising:
one or more storage media storing instructions; and
one or more processors configured to execute the instructions causing the system to perform operations comprising:
executing a game environment, wherein a geofencing application executes in the game environment;
receiving, by the system, a plurality of criteria for establishing a geofence within the gaming environment from a user gaming device associated with a user;
identifying a user location based on location data retrieved from a user device;
establishing the geofence based on the user location and the user provided criteria;
receiving, by the system, a plurality of rules for establishing an interaction within the geofence, wherein the geofence defines a geographical boundary within which the user is allowed to interact with other users based on the plurality of rules;
receiving, by the system, a request for an interaction with the user gaming device from a requesting gaming device;
automatically initiating, by the system, the geofencing application in the game environment;
verifying, by the geofencing application, that the requesting gaming device is within the geofence;
verifying, by the geofencing application, that the requesting gaming device satisfies the plurality of rules for establishing the interaction; and
establishing, by the geofencing application, the interaction between the user gaming device and the requesting gaming device.

10. The system of claim 9, further comprising:
defining, by the system, a plurality of layers within the geofence based on the user provided rules, wherein a plurality of rules for establishing an interaction within an innermost layer of the plurality of layers defined by the geofence are more restrictive than a plurality of rules for establishing an interaction within an outermost layer of the plurality of layers defined by the geofence.

11. The system of claim 10, wherein the plurality of rules for establishing an interaction within the outermost layer comprises parental approval.

12. The system of claim 10, further comprising, in response to determining that the requesting gaming device is in the outermost layer, outputting a request for parental confirmation that the requesting gaming device satisfies the plurality of rules for establishing an interaction.

13. The system of claim 9, wherein verifying that the requesting gaming device is within the geofence comprises identifying at least one secondary electronic device that is in proximity to the requesting gaming device; and verifying that the at least one secondary electronic device is the geofence.

14. The system of claim 9, wherein verifying that the requesting gaming device is within the geofence comprises accessing server information associated with the requesting gaming device, wherein the server information validates a geolocation of the requesting gaming device.

15. The system of claim 9, wherein verifying that the requesting gaming device satisfies the plurality of rules for establishing the interaction comprises accessing a database to identify an electronic account associated with the requesting gaming device, and identifying, from the electronic account, information associated with the requesting gaming device.

16. The system of claim 9, wherein verifying that the requesting gaming device satisfies the plurality of rules for establishing the interaction comprises outputting a request for parental confirmation that the requesting gaming device satisfies the plurality of rules.

17. One or more non-transitory computer-readable storage media storing instructions that, upon execution by one or more processors of a system, cause the system to:
execute a game environment, wherein a geofencing application executes in the game environment;
receive a plurality of criteria for establishing a geofence within the gaming environment from a user gaming device associated with a user;
identify a user location based on location data retrieved from a user device;
establish the geofence based on the user location and the user provided criteria;
receive a plurality of rules for establishing an interaction within the geofence, wherein the geofence defines a geographical boundary within which the user is allowed to interact with other users based on the plurality of rules;
receive a request for an interaction with the user gaming device from a requesting gaming device;
automatically initiate the geofencing application in the game environment;
verify, by the geofencing application, that the requesting gaming device is within the geofence;
verify, by the geofencing application, that the requesting gaming device satisfies the plurality of rules for establishing the interaction; and
establish, by the geofencing application, the interaction between the user gaming device and the requesting gaming device.

18. The non-transitory computer-readable storage media of claim 17, wherein verifying that the requesting gaming device is within the geofence comprises identifying at least one secondary electronic device that is in proximity to the requesting gaming device; and
verifying that the at least one secondary electronic device is in the geofence.

19. The non-transitory computer-readable storage media of claim 17, wherein verifying that the requesting gaming device satisfies the plurality of rules for the respective layer for establishing the interaction comprises accessing a database to identify an electronic account associated with the requesting gaming device, and identifying, from the electronic account, information associated with the requesting gaming device.

20. The non-transitory computer-readable storage media of claim 17, wherein verifying that the requesting gaming device satisfies the plurality of rules for establishing the interaction comprises accessing a database to identify an electronic account associated with the requesting gaming device, and identifying, from the electronic account, information associated with the requesting gaming device.
